(19) United States
(12) Patent Application Publication
(10) Pub. No.: US 2002/0051893 A1
(43) Pub. Date: May 2, 2002

(54) High brightness and low voltage operated LEDs based on inorganic salts as emitters and conductive materials as cathodic contacts

(75) Inventors: Frank G. Gao, League City, TX (US); Mihai Buda, Austin, TX (US); Chong-Yang Liu, Austin, TX (US); Allen J. Bard, Austin, TX (US)

Correspondence Address: Steven L. Highlander, Fulbright & Jaworski L.L.P., 600 Congress Ave., Suite 2400, Austin, TX, 78701, US

(73) Assignee: Board of Regents, The University of Texas System, Austin, TX (US)

(21) Appl. No.: 09/872,163

(22) Filed: May 31, 2001

Related U.S. Application Data
(60) Provisional application No. 60/208,434, filed on May 31, 2000.

(51) Int. Cl. H05B 33/14

(52) U.S. Cl. 428/690; 428/917; 427/66; 313/503; 313/504; 313/506

(57) ABSTRACT

Solid-state light-emitting devices (LEDs) are fabricated based on an amorphous or nanocrystalline film of Ru(bpy)₃(ClO₄)₂ (bpy=2,2′-bipyridine) about 100 nm thick on indium tin oxide (ITO) and printed on stable conductive material including low melting point alloys (Ga:In, Ga:Sn and Bi:In:Pb:Sn) and ITO as cathodic contact. Devices with the structure of ITO(10≦Ω/square)/Ru(bpy)₃(ClO₄)₂/Ga:Sn and the structure of ITO(10≦Ω/square)/Ru(bpy)₃(ClO₄)₂/ITO produces a bright red emission (3500 cd/m² at 4.0 V) centered at 660 nm. This new method significantly simplifies the fabrication of an electroluminescence cell and has potential application in the production of OLEDs by inkjet or microcontact printing. LEDs based on Ru(bpy)₃(ClO₄)₂, Ru(phenanthroline)₃(ClO₄)₂, Os(bpY)3(PF₆)₂, and Tris(8-hydroxyquinoline) aluminum (Alq₃) are also presented.

This application claims priority to provisional application 60/208,434 filed May 31, 2000, herein incorporated by reference.

The government may owns rights to this invention pursuant to Department of Defense contract number 41158-G, OSP number 199900317-001 and National Science Foundation Grant CHE-9876855.

### BACKGROUND OF THE INVENTION

I. Field of the Invention

The present invention relates to the field of molecular solid-state light emitting devices.

II. Related Art

Organic solid-state light-emitting devices (LEDs) may eventually offer an alternative to inorganic semiconductor solid state LEDs (e.g., based on GaAs and GaN) and LCDs in flat-panel displays, perhaps affording flatter, brighter and more flexible displays at lower cost. There has been much research aimed at the development of new organic light-emitting materials (Yang et al., 2000); Chondroudis et al, 2000; Baldo et al., 1999; O'Brien et al, 1999; Tao et al., 1999; Gigli et al., 1999; Berkovich et al., 1999; Zhang et al., 1999; Xu et al., 1999; Curry et al., 1999; Antoniadis et al., 1998; Hamada et al., 1998;. Hamada et al., 1997; Boyd et al., 1997). Among the materials that have been studied, films and polymers based on trischelated ruthenium(II) complexes have recently attracted considerable attention (Maness et al., 1996; Maness et al., 1997; Lyons et al., 1998; Handy et al., 1999; Wu et al., 1999; Elliott et al., 1998). Attempts have been made to increase the duration of operation and to improve the performance of these organic light-emitting materials with dopant in the emitters, (Hamada et al., 1999; Sakamoto et al., 1999; Kido et al., 1994; Sato et al., 1997) dopant in the hole-transport materials (Hu et al., 1999; Chung et al., 1999; Blochwitz et al., 1998; Yamamori et al., 1998), electron-transport materials (Donze et al., 1999; Jandke et al., 1998), transparent electrodes (Kim et al., 2000) and surface treatment of ITO (Choi et al., 2000; Li et al., 1997a). Furthermore, with the realization that the overall improvement of the performance and durability of LEDs is related to the improvement of the metal contact, much research has been focused on understanding the nature of charge injection from contacts (Chone et al., 1998; Campbell et al., 1998; Conwell et al, 1997), metal diffusion and quenching of luminescense (Lee et al., 1999; Huang et al., 1998; Choong et al., 1997), and modification of metal contacts (Li et al., 1997b; Li et al., 1997c; Jabbour et al., 1998). The method commonly used to fabricate a cathodic metal contact relies on vacuum evaporation of low work function metals or alloys such as Ca, Mg, Al, Ag, Mg:Ag and Mg:In.

Like their polymer counterparts, LEDs employing small molecules as emitters have shown commercial potential (Tang, et al., 1987; Yang et al., 2000; Chondroudis et al., 2000; Baldo et al., 1999; O'Brien et al., 1999; Tao et al., 1999; Zhang et al., 1999; Curry et al., 1999; Hamada et al, 1998; Hamada et al., 1997; Hamada et al., 1999 Adachi et al., 1989; Burrows et al., 1994; Kido et al., 1995; Strukelj et al., 1996).

### SUMMARY OF THE INVENTION

The present invention provides a method for producing high brightness from a low voltage driven LED based on an emitter layer film comprising an inorganic salt such as an amorphous or nanocrystalline thin film and using printed low melting point alloys and other conductive materials as cathodic contacts. Exemplary of the inorganic salts is Ru(bpy)₃(ClO₄)₂. Other inorganic salts include other trischelated-ruthenium (II) compounds such as Ru(bpY)₃(PF₆)₂, Ru(bpy)₃(AsF₆)₂, Ru(bpY)₃(BF₄)₂, RU(II)(byp)₂-(bpyCOOR)(ClO₄)₂and Ru(II)(phenanthroline)(ClO₄)₂ and tris(2,2 ′-bipyridine) osmium (II) compounds such as Os(II)(bpY)₃(PF₆)₂. Low melting point alloys include Ga:In, Ga:Sn and Bi:In:Pb:Sn and other contacts include indium tin oxide (ITO) and carbon.

According to the present invention, a single-layer LED is provided based on a spin-coated solid thin films of Ru(bpy)₃(ClO₄)₂ molecules with cathodic contact achieved through the printing of a low melting point alloy such as Ga:In, Ga:Sn or Bi:In:Pb:Sn. The current-voltage and luminance-voltage plots exhibit a diode-like behavior with a preferred turn-on voltage of between 2.1 and 2.5 V, 2.2 and 2.4 V, or even more preferred 2.3 V.

According to the present invention, the cathodic contact and an anodic contact may be made from the same material, such as ITO.

According to the present invention, a brightness of 3500 cd/m² at 4.0 V voltage bias and quantum and power efficiencies of at least 1.4%, 2.4%, 3.4% or more and 0.8%, respectively, are realized. LEDs with greater quantum and power efficiencies are also contemplated. Emission spectra indicate a maximum emission at 640-660 nm that is clearly visible in a lighted room as a bright red emission.

The present invention provides a flat panel display and a lighting fixture comprising an LED comprising an emitter layer comprising a film of an inorganic salt. The present invention also provides a printed eutectic as contact in an LED. This technique has potential application for materials described here and previously used compounds like tris(8-hydroxyquinoline) aluminum (Alq₃) in LED contact fabrication by ink-jet and microcontact printing. LEDs based on C₁₂-Ru(bpy)₃(ClO₄)₂, Ru(phenanthroline)₃(ClO₄)₂ and Os(bpy)₃(PF₆)₂ also are presented.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 is a chemical structures of the major compounds.

FIG. 2 is a structure of the single-layer LED cell.

FIG. 3 is the optical absorption spectrum of a Ru(bpy)₃(ClO₄)₂ thin film on ITO.

FIG. 4A and FIG. 4B:

FIG. 4A is an AFM topograph of a Ru(bpy)₃(ClO₄)₂ thin film on ITO.

FIG. 4B is an AFM line profile of the Ru(bpy)₃(ClO₄)₂ thin film surface with a scratch, showing a thickness of 100 nm.

FIG. 5A and FIG. 5B:

FIG. 5A is a transmission electron microscope image of the Ru(bpy)₃(ClO₄)₂ thin film.

FIG. 5B is an x-ray diffraction pattern of the Ru(bpy)₃(ClO₄)₂ thin film.

FIG. 6 is a Perkin-Elmer thermal analysis of the Ru(bpy)₃(ClO₄)₂ thin film. Sample was held at 50.00C for one minute, heated from 50.00° C. to 200.0° C. at 10.00° C./minute.

FIG. 7 shows light-emitting images from two different locations on an LED consisting of a lithographically fabricated ITO finger electrode, Ru(bpy)₃(ClO₄)₂ active layer, and a Ga:In count electrode. Bias voltage was 3V with ITO positive. The emitted light was clearly seen with an optical microscope. No light was emitted from those areas (appeared dark) where ITO was absent.

FIG. 8 shows current and light intensity as a function of bias voltage from a LED of ITO/Ru(bpy)₃(ClO₄)₂/Carbon paste. Scan rate: 50 mV/s.

FIG. 9 shows images (0.15 mm×0.12 mm) of Ru(bpy)₃(ClO₄)₂ single crystal thin films (about 1.5 μm thick) between two crossed polarizers with an optical microscope. Dark areas are open air spaces. The two corners on the single crystal are 90° and 140°.

FIG. 10A and FIG. 10B:

FIG. 10A is a photograph showing red emissions from two contacts of a single-layer LED ITO/Ru(bpy)₃(ClO₄)₂/Ga:In.

FIG. 10B is an emission spectrum of a single-layer LED ITO/Ru(bpy)₃(ClO₄)₂/Ga:In.

FIG. 11A and FIG. 11B:

FIG. 11A are current-voltage and luminance-voltage plots of a single layer LED (+)ITO/Ru(bpy)₃(ClO₄)₂/Ga:In(−). The voltage scan rate is 0.05 V/S.

FIG. 11B is an external quantum efficiency and power efficiency as a function of the voltage bias.

FIG. 12A and FIG. 12B:

FIG. 12A is an external quantum efficiencies, and

FIG. 12B power efficiencies, of a group of single-layer LED ITO/Ru(bpy)₃(ClO₄)₂/Ga:In (left) and double-layer LED ITO/Ru(bpy)₃(ClO₄)₂/Ga:In (right)

FIG. 13A and FIG. 13B:

FIG. 13A is a current and luminance rise curves against time upon application of 3.0 V voltage bias for the LED ITO/Ru(bpy)₃(ClO₄)₂/Ga:In.

FIG. 13B is same as FIG. 13A but in a 2 h term.

FIG. 14 is a current-voltage and luminance-voltage plot of a single-layer LED using 10 Ω/square ITO as substrate, i.e. ITO(10 Ω/square/Ru(bpy)₃(ClO₄)₂/Ga:In. The voltage scan rate was 0.50 V/s.

FIG. 15 is a current-voltage and luminance-voltage plot of a single-layer LED with a semitransparent gold layer inserted between ITO and the emitter layer, i.e. ITO(10 Ω/square/Ru(bpy)₃(ClO₄)₂/Ga:In. The voltage scan rate was 0.50 V/s.

FIG. 16 show current and light intensity curves as a function of bias voltage from a single crystal LED of ITO/Ru(bpy)₃(ClO₄)₂/ITO. Scan rate: 50 mV/s. Curves are overlapped each other on over 30 consecutive scans into both directions.

FIG. 17 is a relative energy levels of the anode, HOMO and LUMO of Ru(bpy)₃(ClO₄)₂ emission, and the metal cathode.

FIG. 18 is a schematic representation of the bimolecular hopping mechanism for the EL of Ru(bpy)₃(ClO₄)₂-based LEDs.

FIG. 19 are photoluminescence confocal microscope CCD pictures of an LED ITO/Ru(bpy)₃(ClO₄)₂/Ga:In. The contact at the upper right corner had been operated for 100 h at 4.5 V bias, showing no or very weak fluorescence. The remaining three contacts, without operation, show intense red fluorescence. Excitation 470 nm, emission 515 nm LP, magnification 8, exposure time 1 s.

FIG. 20 (dotted line) is the optical absorption spectrum of an ITO/Ru(bpy)₃(ClO₄)₂ film before operation and the solid line in the same area, a Hg contact was made, and a 8.0 V voltage bias was added for 5 h, then the Hg contact was removed and an optical absorption spectrum of the ITO/Ru(bpy)₃(ClO₄)₂ film in the same area was measured.

FIG. 21 is an emission spectrum of a single-layer LED ITO/C₁₂-Ru(bpy)₃(ClO₄)₂/Ga:Sn.

FIG. 22 is an emission spectrum of a single-layer LED ITO/Ru-(phenanthroline)₃(ClO₄)₂/Ga:Sn.

FIG. 23 shows luminance transients for a ITO/Ru(byp)₃(X⁻)₂/GaSn device. Top, left, X⁻=BF₄⁻(2.5 V,˜150 nm); top right, ClO₄⁻(2.5 V,˜150 nm); bottom left, PF₆⁻(2.5 V,˜200 nm); bottom right, AsF₆⁻(3.0 V,˜350 nm).

FIG. 24 is a typical zero-bias impedance spectra for Ru(byp)₃(X⁻)₂ (A˜0.008 cm², 1 mHz-100 Hz).

FIG. 25 is an emission spectrum of a single-layer LED ITO/Os(bpy)₃(PF₆)₂/Ga:Sn.

FIG. 26 shows current and luminance curves against time upon application of 5.0 V voltage bias for the LED ITO/Os(bpy)₃(PF₆)₂/Ga:Sn.

FIG. 27 is an emission spectrum of a single-layer LED ITO/Alq₃/Ga:Sn.

### DESCRIPTION OF THE PREFERRED EMBODIMENTS

The present invention is drawn to chemical compounds and their use in light emitting devices (LEDs). LEDs are useful in a variety of applications including use in watches, telephones, laptop computers, pagers, cell phones, calculators, lighting fixtures and the like. See, for example, U.S. Pat. Nos. 5,693,956; 5,151,629; 5,707,745; and 5,703,436 for conventional LED devices, each of which are incorporated herein by reference.

The subject invention disclosed herein also may be used in conjunction with the subject matter of U.S. Pat. Nos. 5,757,139; 5,707,745; 5,721,160; and 5,757,026 dealing with displays, each of which are incorporated by reference.

LED's of the present invention use an inorganic salt rather than an organic thin film and find particular use in flat panel displays, for example, those described in U.S. Pat. Nos. 6,000,983; 6,015,120; 6,020,874; 6,023,258; 6,023,790; 6,024,335; 6,028,977; 6,029,831; 6,050,535; 6,059,626; 6,061,104; 6,064,373; and 6,031,714, each of which are incorporated by reference.

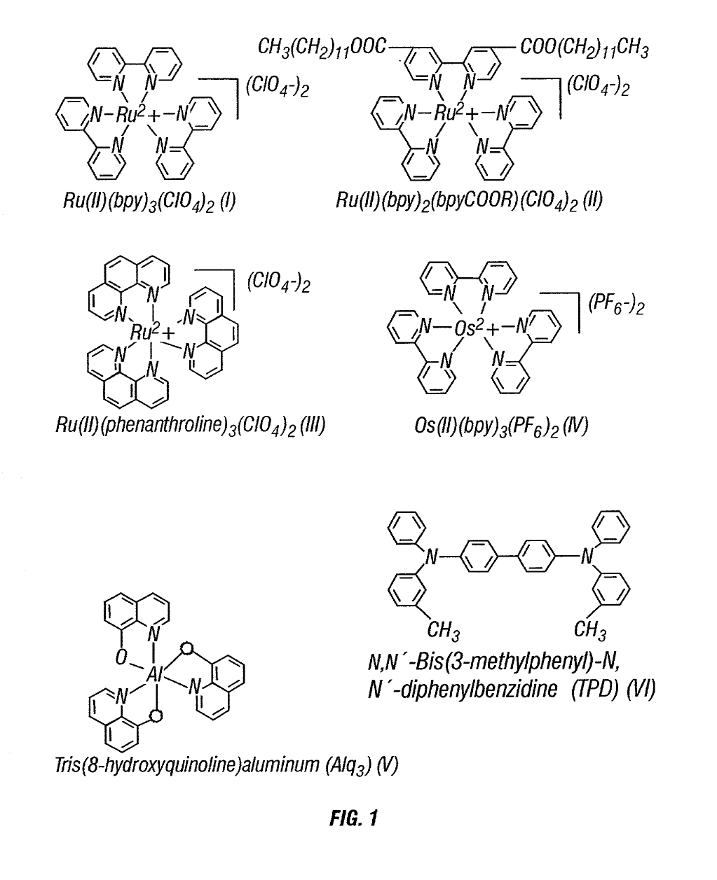

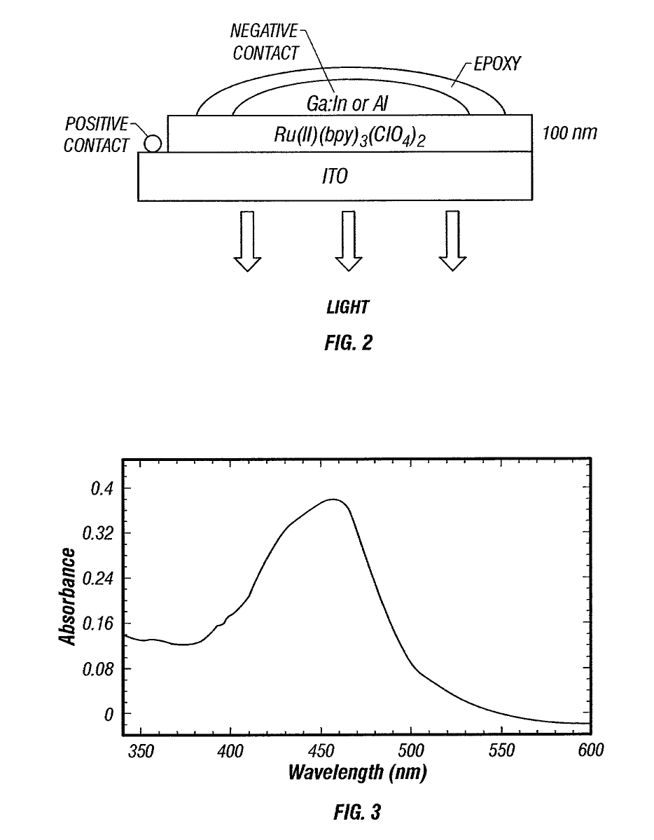

The chemical structures of the major compounds are shown in FIG. 1. Commercially available Ru(bpy)₃(Cl₂ (Aldrich) is converted to Ru(bpy)₃(ClO₄)₂ by a metathesis reaction with an excess of NaClO₄ (Fluka), then recrystallized twice from an ethanol+acetone (5:1) solution (McCord, P., 1991). The perchlorate salt is then dried in a vacuum oven at 125° C. Ru(bpy)₃²⁺ compounds with other anions were prepared similarly with the appropriate sodium salt. The synthesis of the derivative of C₁₂Ru(bpy)₃(ClO₄)₂follows the procedure reported previously (Sprintschnik et al., 1997). Ru(phenanthroline)₃(ClO₄)₂ is prepared according to the same procedure (McCord, P., 1991), converted from commercially available Ru(phenanthroline)₃(Cl)₂ (Aldrich). Os(bpy)₃(PF)₆)₂ is synthesized using a procedure described elsewhere (Gaudiello et al., 1984). N,N′-bis(3-methylphenyl)-N,N′-diphenyl-benzidine (TPD) and tris(8-hydroxyquinoline) aluminum (Alq₃) can be purchased from Aldrich. Indium tin oxide 2 substrates (ITO, 1.6×2.2 cm², Delta Technologies, Ltd., 100 Ω/square except where indicated) are cleaned by sonication in an 80° C. ethanolamine+H₂O (20:80) bath for 20 min, then rinsed and sonicated several times in highly purified Millipore Milli-Q water (18 MΩ cm) and dried in an oven at 95° C. The structure of a single-layer LED cell is shown in FIG. 2.

Film Preparation, Spin Coating.

Thin films (about 100 nm thick) of Ru(bpy)₃(ClO₄)₂ are spin-coated onto ITO substrates from a 4% (w/v) acetonitrile (Burdick & Jackson, UV grade) solution at room temperature. The Ru(bpy)₃(ClO₄)₂ solution is first filtered through a 0.2 μm nylon syringe filter to remove any large particles. Films are heated in a vacuum oven at 125° C. for at least 8 hours. Thin films (ca. 80 nm thick) of C₁₂-Ru(bpy)₃(ClO₄)₂ are spin-coated onto ITO sheets from 4% (w/v) pentanone solution. TPD can be inserted between ITO and the emitter layer, where it functions as a hole transporter layer. In these cells, 0.7% TPD (w/v) xylene solution is used to form a 20 nm thin film by spin-coating. Ga:In (75.5:24.5 wt %, m.p. 15.7° C.) or Ga:Sn (92.8 wt %, m.p. 20° C.) eutectic cathodes (ca. 3 mm diameter) are printed on top of the films at room temperature using a syringe, then connected via a thin copper wire inserted into the Ga:In or Ga:Sn balls. Both are then sealed with 5 min epoxy cement (Devcon, Danvers, Mass.). The light-emitting active area (hereafter referred to as a 2 contact) is about 7 mm². Typically, four contacts are fabricated for each LED, i.e., for each piece of ITO. In the production of Bi:In:Pb:Sn (49:21:18:12 wt %, m.p. 58° C.) contacts, the alloy is first melted, drawn into a syringe, kept in an oven at 80° C., and then printed on the top of the film. All eutectics were purchased from Alfa Aesar. For comparison, vacuum evaporated aluminum contacts were also fabricated. For single-layer LEDs based on Alq3, a thin film was spin-coated onto ITO from an Alq₃ saturated pyridine solution. Then the same procedure used in making a Ru(bpy)₃(ClO₄)₂ device is followed. Spin-coating of thin film can be carried out by a Headway Model E101 spinner. All LEDs are fabricated in a laminar flow hood under ambient conditions.

Film Preparation, Lithography.

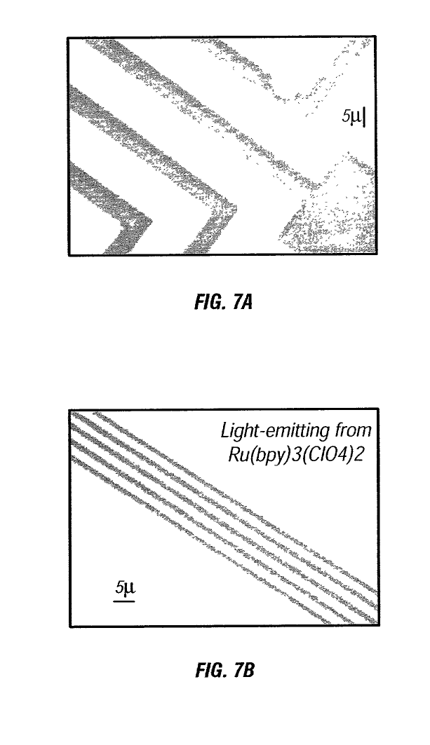

The thin films can also be created using lithographic techniques. ITO finger electrodes (Hewlett-Packard) have been lithographically fabricated into five parallel and separated fingers down to sub-micron level and a Ga:In tip was employed as a liftable electrode controlled by a micro-meter. Since the Ga:In alloy does not wet the film surface well, it is quite easy to make a contact at few tens of an μm and the tip could be relocated at different area facing the ITO fingers with the same or different size. As expected, light was seen only from those areas where ITO was presented as shown in FIG. 7. These two images were taken with an optical microscope and the sample was biased at 3 V with ITO positive. Interestingly, defects on the ITO electrode resulted from the wet etching were clearly visible and the light from the edge appeared a bit brighter. The active layer was about 0.1 μm thick. The thinner ITO fingers shown here are about 0.9 μm wide and are separated from each other by 1.1 μm. This image also shows wider ITO fingers that were used to connect the LED to the external circuit. It is conceivable that when two lithographically fabricated finger electrodes crossed each other, a square shape LED array could be made.

Current-voltage, luminance-voltage, current-time and luminance-time characteristics are measured at room temperature which can be with an Autolab GPES (General Purpose Electrochemical System, ECO Chemie BV, The Netherlands) and a Newport Optical Power Meter (Model 1830-c) equipped with a 818-UV semiconductor detector (1 cm²) connected to the Autolab GPES via its auxiliary second ADC signal input ports. The reference and counter electrode leads of the Autolab GPES potentiostat are short so that the proper voltage bias is present at the LED electrodes. The emission spectra can be measured with a Model CH210 CCD camera equipped with a monochrometer and coLED to −125° C. The optical absorption spectra were measured with a Milton Roy (San Leandro, Calif.) Spectronic 3000 diode array UV-vis spectrophotometer. Digital photographs and optical microscopy were recorded with an Olympus BH-2 microscope equipped with a Pixera digital visual system. Digital fluorescence microscopy CCD pictures can be taken with a confocal optical microscope (Olympus SZX12) equipped with 470 nm (excitation) and 515 nm long-pass (emission) filters. AFM images can be captured using a Nanoscope III with an AFM 619E-Z head (Digital Instruments, Santa Barbara, Calif.) using a SiN tip in the contact mode. SEM images can be measured. Vacuum evaporation of A1 contacts can be carried out with an evaporator from Vacuum Engineering Company, Inc.

Ru(bpy)₃(ClO₄)₂ Thin Film Characteristics.

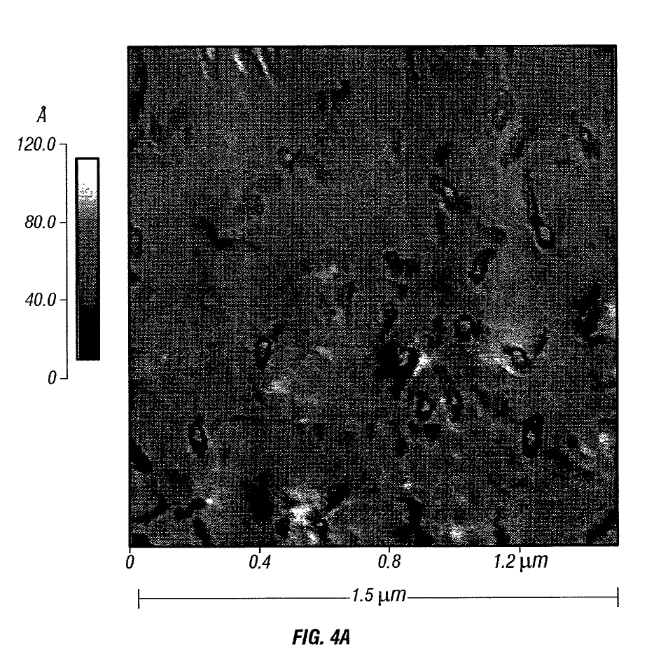

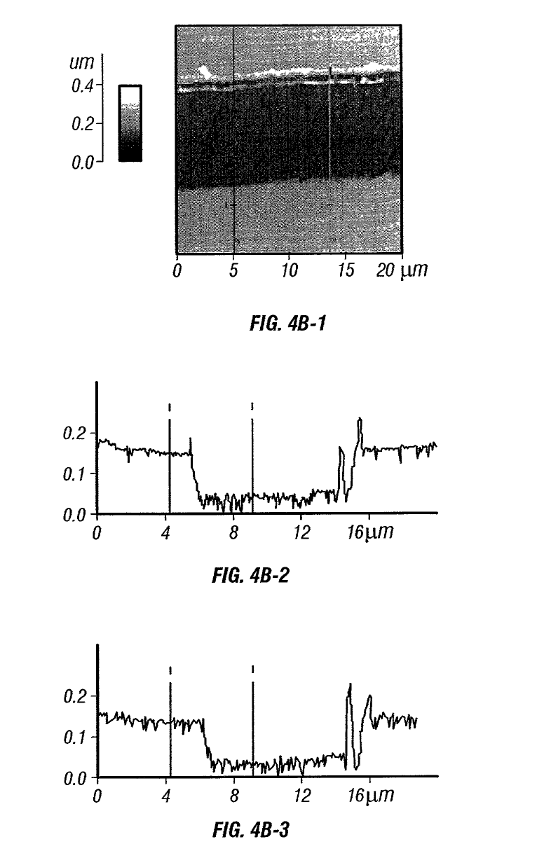

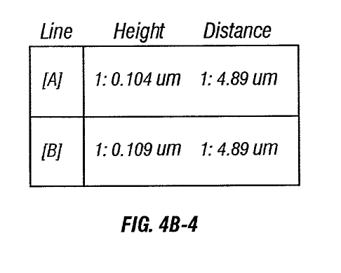

FIG. 3 is the optical absorption spectrum of a Ru(bpy)₃(ClO₄)₂ thin film on ITO, indicating a maximum absorption at 455 nm. An optical microscope image of the Ru(bpy)₃(ClO₄)₂ thin film shows a relatively smooth and uniform surface. The AFM topograph of a Ru(bpy)₃(ClO₄)₂ thin film on ITO in FIG. 4A shows a roughness of about 40 nm. A 100 nm thin film thickness was determined by making a light scratch on the surface and measuring the AFM line profile across it (FIG. 4B).

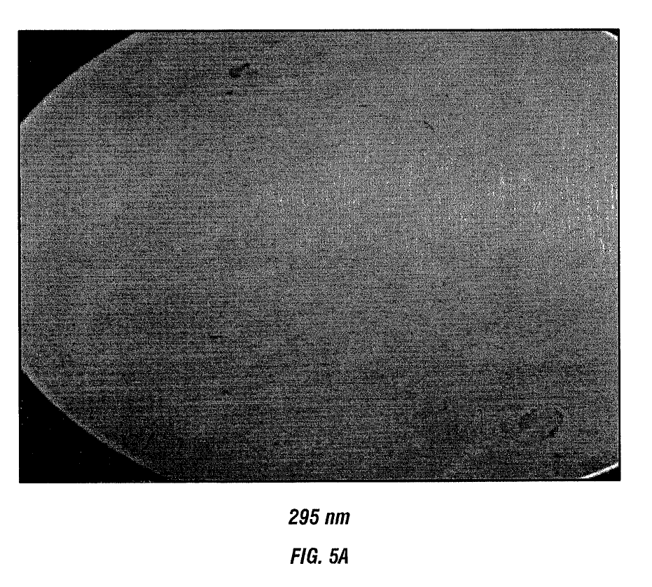

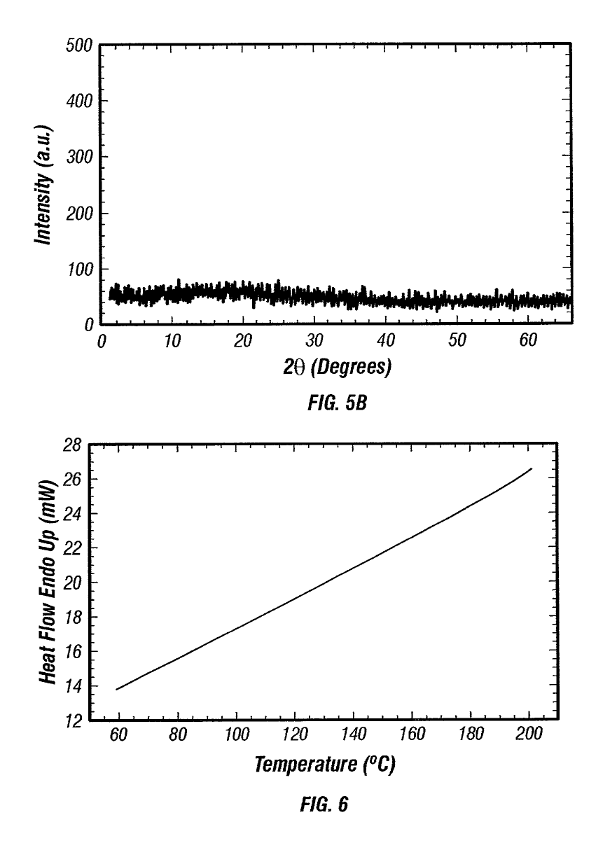

FIG. 5A is a transmission electron microscope image of Ru(bpy)₃(ClO₄)₂ films which suggests the films are amorphous. That the Ru(bpy)₃(ClO₄)₂ films are amorphous is also confirmed by the x-ray diffraction pattern of the film in FIG. 5B. The Ru(bpy)₃(ClO₄)₂ films are solid, i.e., contain no solvent, as can be seen from the Perkin-Elmer thermal analysis of the thin film in FIG. 6.

Crystalline thin films.

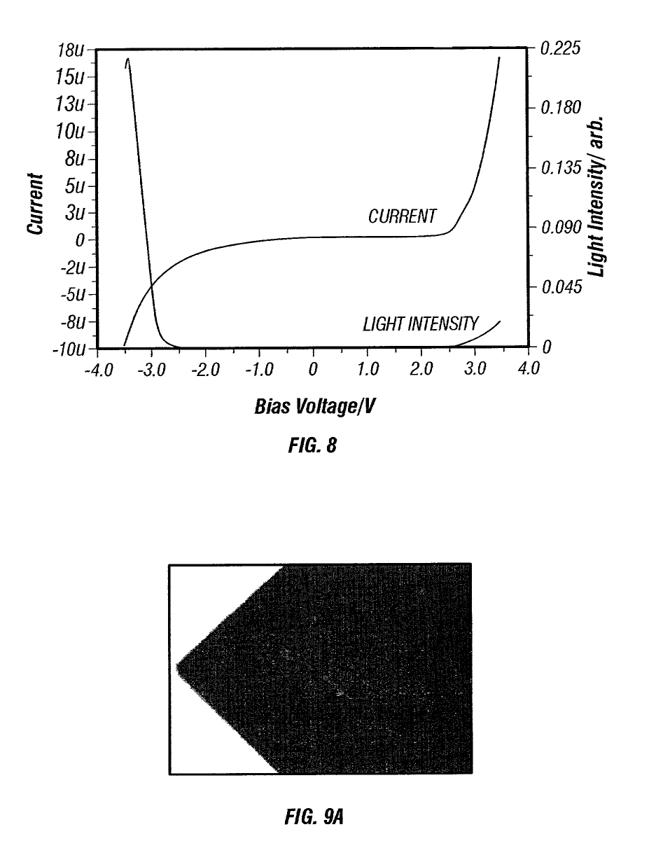

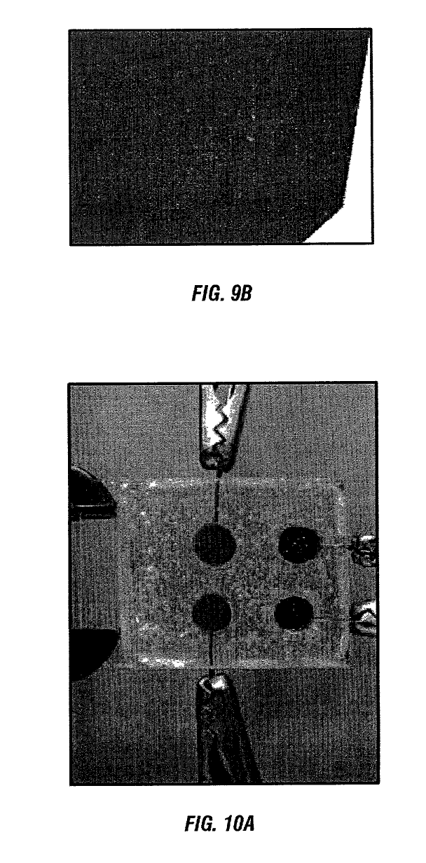

Crystalline as well as amorphous films can be used in the current invention. LEDs were fabricated using a single active layer sandwiched between two ITO electrodes, (i.e., ITO/Ru(bpy)₃(ClO₄)₂ /ITO). Since Ru(bpy)₃(ClO₄)₂ does not melt at high temperature, the procedure of capillary filling (Liu, C. -Y. et al, 1999) could not be used. Alternatively, the inventors found that a near saturated acetonitrile solution with Ru(bpy)₃(ClO₄)₂ could be filled into the empty ITO cells producing crystals after the solvent was evaporated at 105° C. in an oven. Repeated fillings eventually led to the formation of sub-mm scale single crystal thin films (˜1.5 μm thick) of Ru(bpy)₃(ClO₄)₂ within the two ITO electrodes as shown in FIG. 8, which was obtained between two crossed polarizers with an optical microscopy. Note that only single crystal thin film has a chance to show colors between two crossed polarizers and the dark areas shown in the images are simply the open space in the cell. As expected these single crystal thin films have sharp corners such as 90° and 140° shown in FIG. 9. Systematic measurements of the polarized absorption spectrum (Saito, T. et al., 1997) indicated that the Ru(bpy)₃(ClO₄)₂ single crystal oriented with b and c axes being perpendicular and parallel to the ITO surface, respectively (Krausz, E. et al., 1995).

Ru(bpy)₃(ClO₄)₂-based LEDs.

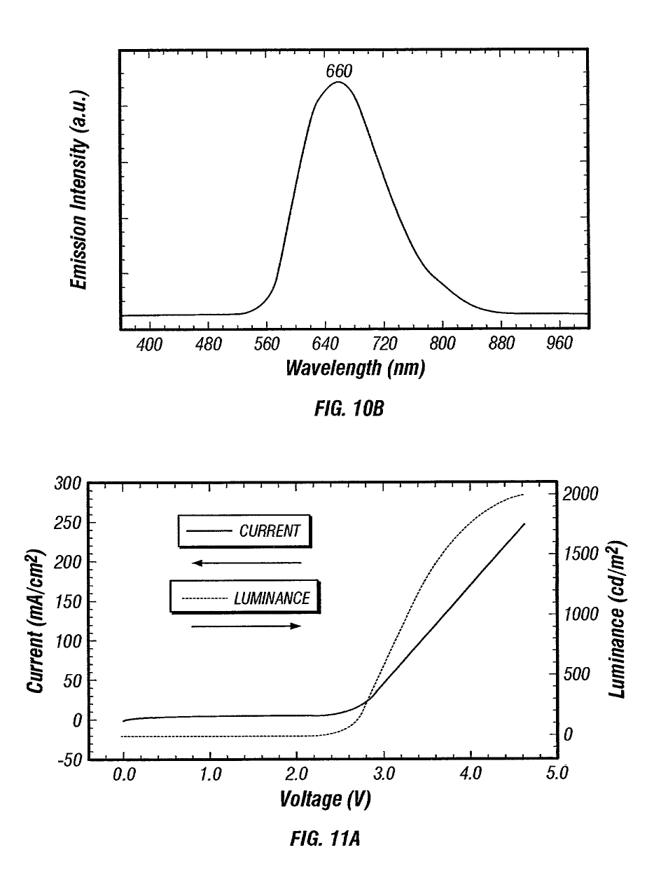

FIG. 10A is a photograph showing emission from 2 contacts of a single-layer LED with the structure of (+)ITO/Ru(bpy)₃(ClO₄)₂/Ga:In(−) (forward voltage bias) at 3.0 V. The bright red emission was clearly visible in a lighted room. Similar emission was obtained for the LEDs using Ga:Sn, Bi:In:Pb:Sn or A1 as the contact. FIG. 10B shows the emission spectrum of the LED using Ga:In as cathodic contact, indicating maximum emission at 660 nm, a half-maximum width of 140 nm and a relatively long tail towards the red. There is at most a very small (ca. 10 nm) blue shift when the voltage bias increases from 3.1 V to 9.4V.

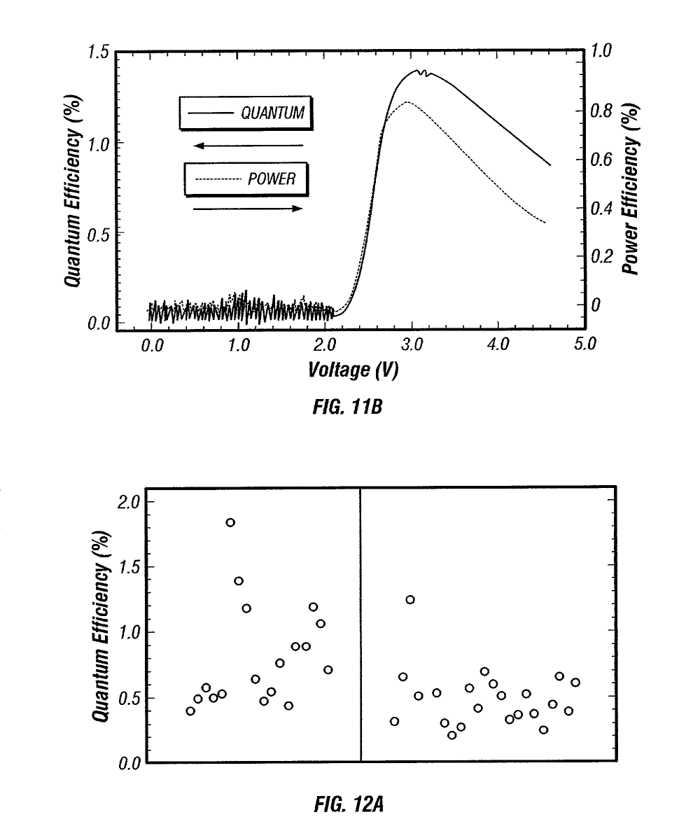

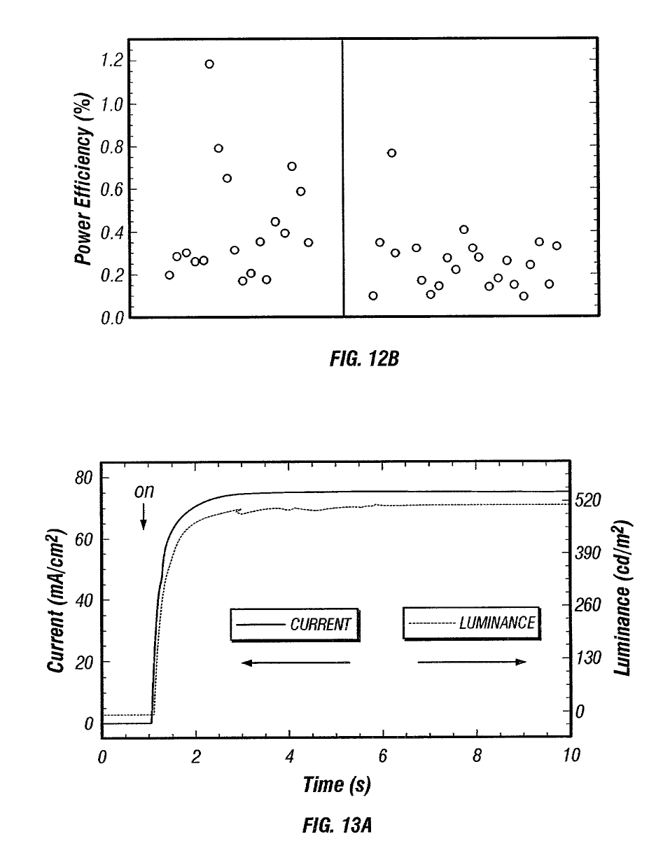

FIG. 11A shows the current-voltage and luminance-voltage plots of a single-layer LED (+)ITO/Ru(bpy)₃(ClO₄)₂/Ga:In(−) (forward voltage bias). The LED showed a turn-on voltage of about 2.3 V for both current and emission. The device reached a luminance level of 500 cd/m² at 3 V and a maximum luminance of 2000 cd/m² at about 4.5 V. Plots of external quantum efficiency and power efficiency as a function of voltage bias in FIG. 11B show that with a voltage bias about 2.3 V the quantum efficiency and power efficiency rapidly increase with voltage. At about 3.0 V, they reached maximum values of 1.4% and 0.8%, respectively, then slowly decreased with a further increase in voltage. Results from a group of LEDs prepared by the same procedure showed considerable variations in external quantum efficiency ranging from 0.4% to 1.8%, and power efficiencies of 0.2% and 1.2% (FIG. 12 (upper and lower left)).

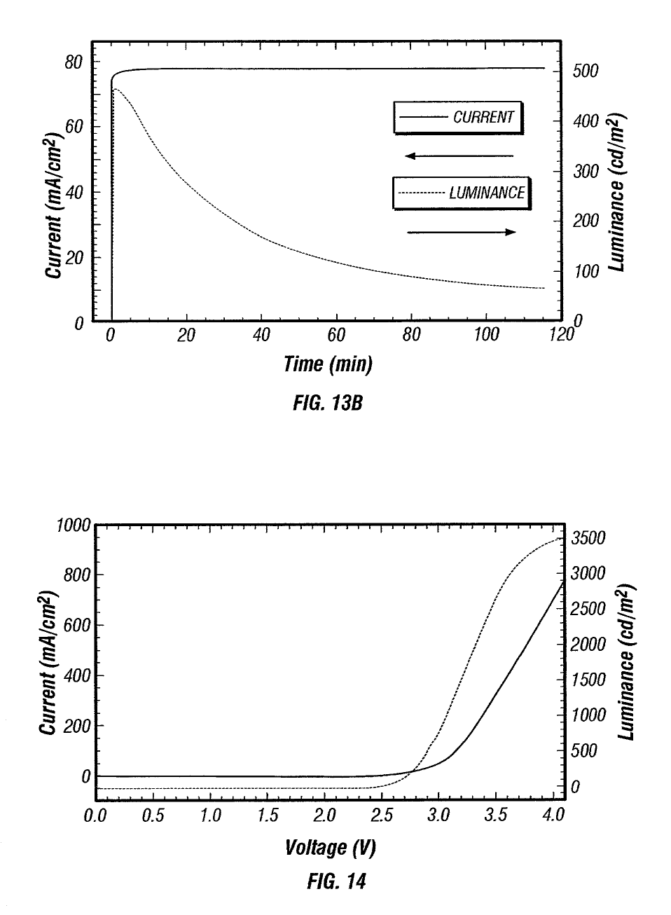

FIG. 13A shows the current and luminance curves against time upon application of a 3.0 V voltage step. The time delay for the rise of the emission was only about 0.02 s, with about 1-2 s needed to reach the maximum luminance output. Variations in delay time were observed among the devices, ranging up to 1-5 s. The emission began to decrease soon after it reached the maximum, as shown by a time course of both the current and luminance (FIG. 13B). Typically, the luminance declined by more than 50% in 1 h. The intensity of the emitted light continued to decrease over several hours and then maintained a nearly steady level. After 5 h, the emission was still visible with an intensity of about 20 cd/m². The higher the applied voltage, the shorter the delay time for the emission rise, and the shorter the time for emission to decay to one-half its initial value. It should be noted that, in contrast to the rapid decrease of the luminance, the current fell slightly, if at all.

The term “high brightness” means that the intensity of the light emitted from the device is high when compared to LEDs and LCDs that are not high brightness devices. A device emitting 500 cd/m², 1,000 cd/m², 2,000 cd/m², 3,000 cd/M² or even more preferably 3,500 or more cd/m² is a high brightness device. The term “low voltage” means that the turn-on voltage is less than 3.5 V or more preferably less than 3.0 V, or even more preferably less than 2.5 V. The term “thin film” means that the film is less than 1000 nm in average thickness. It is preferred that the thin film is less than 200 nm thick.

Influence of a TPD Hole Transport Layer.

For comparison, the inventors also investigated the LEDs with TPD as a hole transporter inserted between ITO and the Ru(bpy)₃(ClO₄)₂ layer, ITO/TPD/Ru(bpy)₃(ClO₄)₂/Ga:In. Results of a group of some 20 bilayer LEDs showed about the same performance as that revealed in FIG. 12 (right). Thus, a TPD layer did not significantly improve the performance of the LED cells. Their performance appears to be governed largely by the quality of the Ru(bpy)₃(ClO₄)₂ thin films formed on ITO substrates.

Influence of ITO Resistivities.

The inventors typically use ITO with a resistivity of 100 Ω/square. To understand the influence of ITO resistivity on the performance of LEDs, the inventors tested similar LEDs fabricated by the same process mentioned above but using 10 Ω/square ITOs. FIG. 14 shows the current-voltage and luminance-voltage plots of a single-layer LED with the structure of ITO (10 Ω/square)/Ru(bpy)₃(ClO₄)₂/Ga:In. The LED showed a very similar current-voltage and luminance-voltage behavior to those using 100 Ω/square ITO, though with greater current density and hence emission at a relatively low field, reaching 3500 cd/m² at 4.0 voltage bias. Quantum and power efficiencies showed no improvement over those obtained using 100 Ω/square ITO.

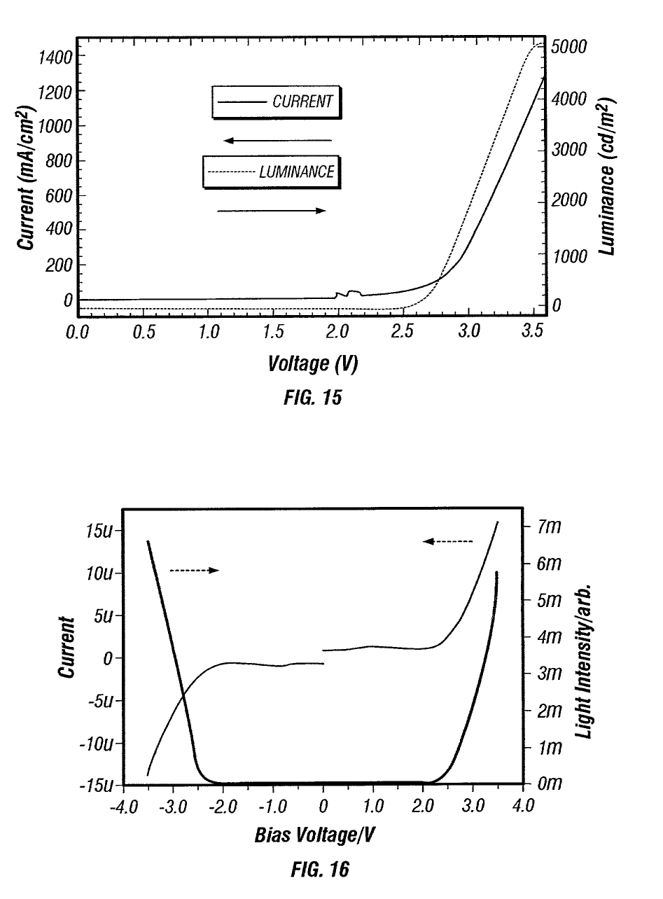

FIG. 15 indicates that a much higher current density (hence a greater emission intensity) for LED ITO/Au//Ru(bpy)₃(ClO₄)₂/Ga:In, i.e., an LED with about a 10 nm semi-transparent gold film inserted between ITO and the Ru(bpy)₃(ClO₄)₂ film. For this device a luminance as high as 5000 cd/m² at 3.5 V was realized. However, as with LEDs using varied resistivities, there is no significant difference between the devices with an Au film inserted between the ITO and the Ru(bpy)₃(ClO₄)₂ and those without one.

Varied Cathodic Contacts.

In addition to Ga:In, the inventors used other alloys such as Ga:Sn and Bi:In:Pt:Sn, as cathodic contacts. Bright red emission from 2 contacts of a single-layer LED with the structure ITO/Ru(bpy)₃(ClO₄)₂/Ga:SN(−) at 3.0 V was clearly visible in a lighted room. Ru(bpy)₃(ClO₄)₂-based LEDs using Ga:In, Ga:Sn and Bi:In:Pt:Sn as cathodic contacts show very similar performance in current-voltage and luminance-voltage behavior, turn-on voltage, emission spectra, etc. The current-voltage plots of LEDs using those low melting alloys as contacts show current behavior that is space-charge limited, not contact limited, indicating a relatively low Schottky energy barrier at the interface of Ru(bpy)₃(ClO₄)₂/M (M=Ga:In, Ga:Sn and Bi:In:Pt:Sn). Evaporated aluminum and printed Hg were also used as cathodic contacts, and visible red emissions were obtained from those LEDs using Al and Hg contacts. These contacts also can be used with more conventional LED materials, such as Alq₃ and polymers like polyphenylenevinylene (PPV).

Other conductive materials that may be used as contacts include other metals such as ITO, gold, platinum, ruthenium and palladium as well as carbon contacts such as carbon paste and graphite.

Characterization of LEDs with ITO contacts.

Light emitting from ITO/Ru (bpy)₃(ClO₄)₂ /Ga:In was essentially detectable only when the ITO electrode was positively biased (Gao et al., 2000). However, a cathodic current was observed when a negative bias voltage was applied to the ITO electrode. To figure out if this was caused by a possible inability to inject electron from the ITO electrode into the active layer, a carbon paste, which was made from a mixture of carbon powder with mineral oil, was used to replace the contact electrode of Ga:In. It was found that both current and light were seen in each direction of the potential scan as shown in FIG. 8. This indicated that ITO was indeed capable of injecting both charge carriers into the active layer. Interestingly, stronger light emitting was observed when the ITO was negatively biased. Despite the absorption effect from the dark carbon paste, the external quantum efficiency (photons over electrons) of about 0.15% was obtained at the peak of the light-emitting curve at about −3.45V. Moreover, the turn-on voltage was very close to that obtained with Ga:In electrode. In addition, when a bias voltage was applied to two neighboring ITO fingers (without a counter electrode such as Ga:In or carbon paste), light emission similar to a surface LED was also observed, suggesting again that ITO electrode was able to inject both electron and hole. In the case of ITO/Ru(bpy)₃(ClO₄)₂ /Ga:In, the contacted electrode of Ga:In was simply oxidized producing a current without light emission, when the ITO electrode was negatively biased. Interestingly, the spin-coated film of Ru(bpy)₃(ClO₄)₂ appeared quite stable, a 6-month old film which had been stored in air still worked well with either Ga:In or Carbon paste.

Indeed, light was emitted from the ITO/Ru(bpy)₃(ClO₄)₂ (crystalline)/ITO cell under both positive and negative bias (FIG. 16). A striking characteristic in this figure is that the curves of current & light intensity as a function of bias voltage basically overlapped each other among over 30 sequential scans of the bias voltage to both directions. Hysteresis was never observed. Another interesting phenomenon in this figure is that the turn-on voltage was essentially identical to spin-coated film (100 nm) LEDs about 15 times thinner than this crystalline LED. Since the conductivity is significantly higher in the single crystalline thin film, iR drop became negligible. Note also that light intensity shown on the left consistently appeared a bit stronger.

An external quantum efficiency of 3.4%, significantly higher than these reported before (Gao et al., 2000; Handy et al., 1999), for light emitting from the symmetrical sandwich cell was obtained. Note that no special care was taken to avoid oxygen and moisture from the initial cell preparation to the end measurement stage. Preliminary stability tests under a fixed bias voltage of 3.5 V for continuous operation showed that the emitted light intensity was stable over 74 hours without decay comparing to a lifetime of only few hours reported with amorphous cells (Gao et al., 2000; Handy et al., 1999). ITO/Ru(bpy)₃Cl₂/ITO was also fabricated for comparison. Since Ru(bpy)₃C₁₂ is highly soluble in water, a saturated aqueous solution was used for the filling. Again, crystalline thin films were obtained and symmetrical I vs. V curves, which overlapped each other on repeated scans similar to FIG. 16, were observed.

Mechanism of Electroluminenscence.

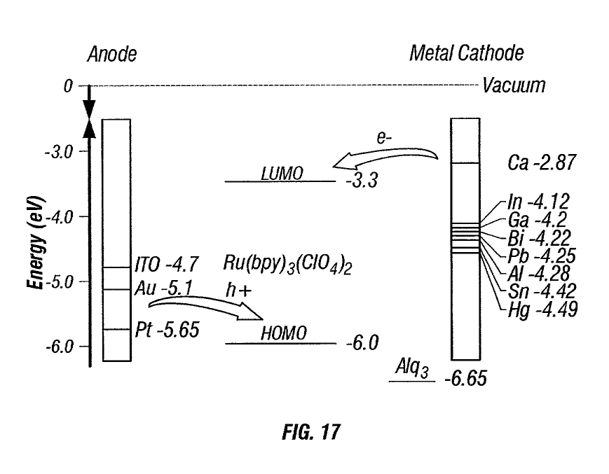

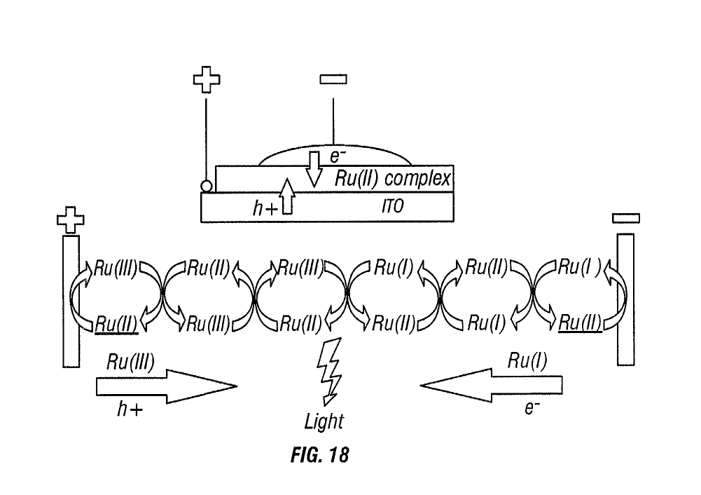

FIG. 17 shows the relative energy levels of the anode, HOMO and LUMO of the Ru(bpy)₃(ClO₄)₂ emitter and the metal cathode. The inventors believe that the EL mechanism in the solid state is similar to the ECL mechanism in solution and that luminescence arises by annihilation of Ru(bpy)₃(III) and Ru(bpy)₃(I), but via charge hopping rather than ion diffusion. As shown in FIG. 18, electrons are injected from the cathode into the Ru(bpy)₃(ClO₄)₂ film forming the Ru(bpy)₃(I) sites. The Ru(bpy)₃(I) sites migrate toward the center by electron hopping. Holes are injected from the anode and form the Ru(bpy)₃(III) sites. The Ru(bpy)₃(III) sites likewise migrated toward the center by charging hopping. The Ru(bpy)₃(I) sites meet at a certain layer inside the film and form Ru(bpy)₃(II)* sites by annihilation reactions between the Ru(bpy)₃(I) sites and the Ru(bpy)₃(III) sites. The balance between electron injection and hole injection affects the quantum efficiency: excess electrons or holes will be non-radiatively wasted, migrating to the opposite electrode without undergoing annihilation reactions. Some motion of counter ions (like ClO₄⁻) also occurs during the charge injection process.

Mechanism of Emission Decay.

A major problem with Ru(bpy)₃(ClO₄)₂-based LEDs is their relatively short emission lifetime. To improve this, it is necessary to understand the emission decay mechanism. Since the results discussed above were obtained with LEDs fabricated in ambient conditions, the inventors tested LEDs fabricated in air in a dry Ar environment, but found no significant improvement in emission lifetime. The inventors also changed anode materials from ITO to ATO (antimony-doped tin oxide) and Au, again noting no improvement in emission lifetime. Furthermore, the inventors found that LEDs using various cathodic contacts, such as Ga:In, Ga:Sn, Bi:In:Pt:Sn, Al and Hg, showed similar emission decay.

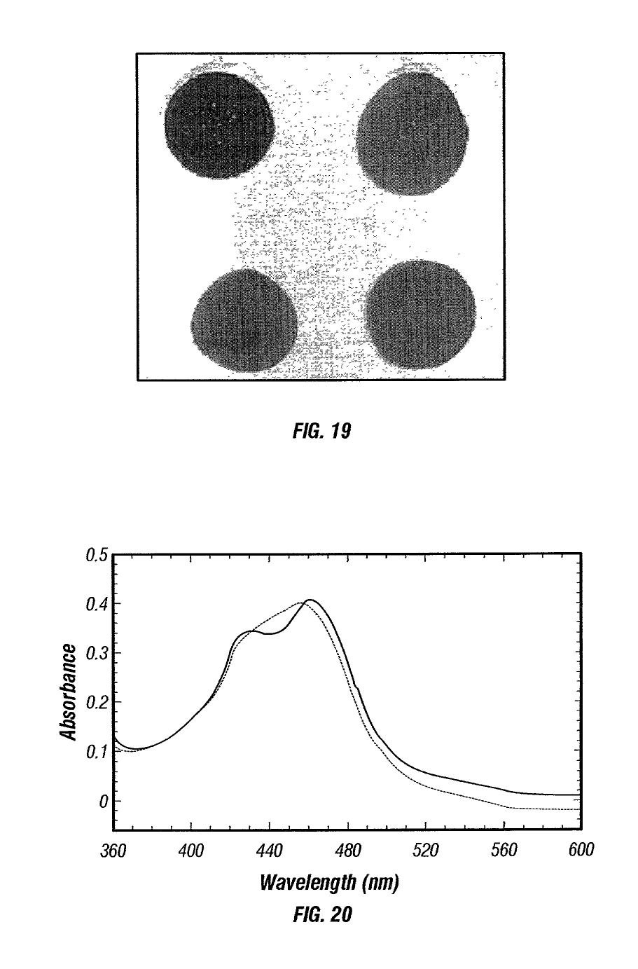

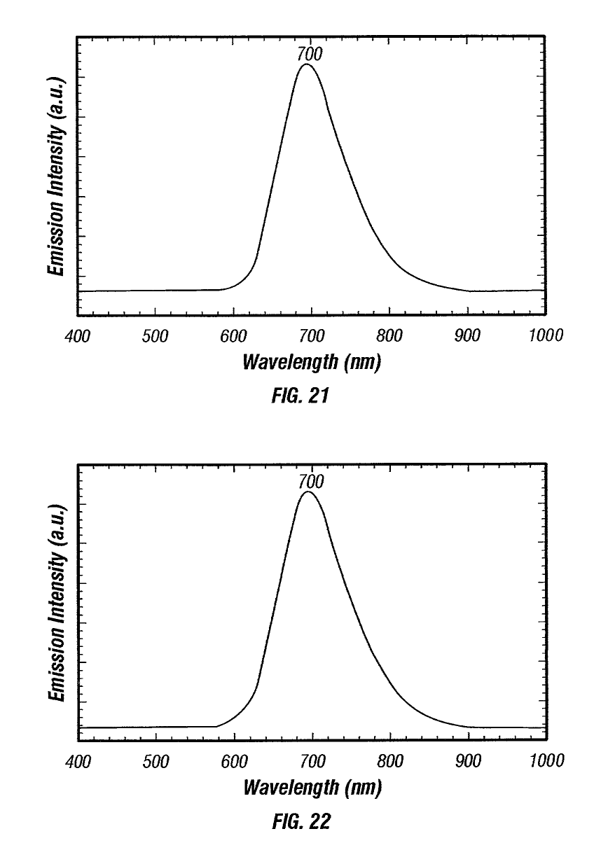

FIG. 19 is a photoluminescence confocal microscope CCD picture of an LED ITO/Ru(bpy)₃(ClO₄)₂/Ga:Sn. The film under the contact at the upper right corner that was operated for 100 h at 4.5 V voltage bias, showed no or very weak fluorescence, while the films under the remaining contacts that were not operated showed intense red fluorescence. Decrease in fluorescence intensity are seen with operation time for operation times of up to 72 h.

The Ru(bpy)₃(ClO₄)₂ compound is thermally stable: no evidence of its decomposition in the film was noted after one hundred hours of operation. FIG. 20 (dotted line) shows the optical absorption spectrum of an ITO/Ru(bpy)₃(ClO₄)₂ film before operation. A Hg contact was made to the same ITO/Ru(bpy)₃(ClO₄)₂ film and an 8.0 V voltage bias was added, resulting in a bright red emission which decayed with time. After 5 h of operation, the Hg contact was removed and an optical absorption spectrum of the ITO/Ru(bpy)₃(ClO₄)₂ film in the same region was measured. This is shown in FIG. 20 (solid line). No significant decrease in absorbance of Ru(bpy)₃(ClO₄)₂ was observed. However, the optical absorption spectrum of the film after operation showed two clearly isolated vibronic waves. The reason for this is not known.

The inventors propose that the continuous emission decay is accounted for, not by the decomposition of the Ru(bpy)₃(ClO₄)₂ compound, but by a quenching process of the Ru(bpy)₃(ClO₄)₂ excited state. The impuritiesin the Ru(bpy)₃(ClO₄)₂ film may play a role in the quenching of the excited state. It is also possible that migration of metal ions from the contacts into the film plays some role in the process.

Transient Behavior.

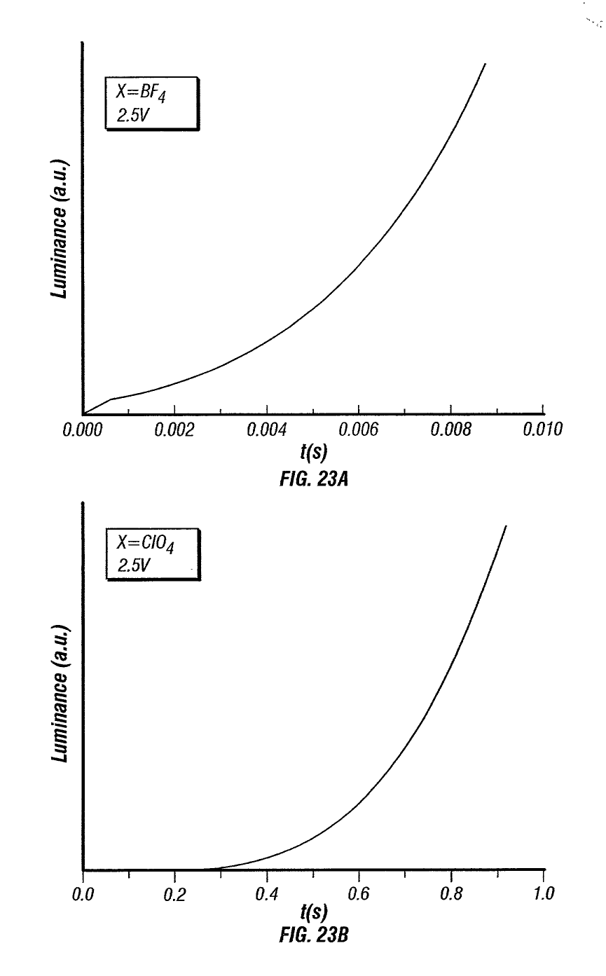

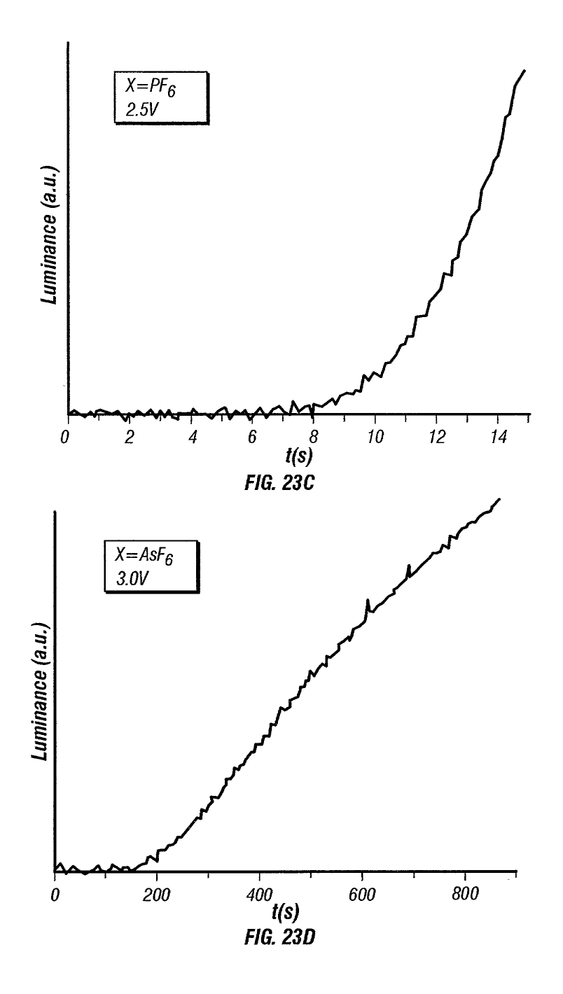

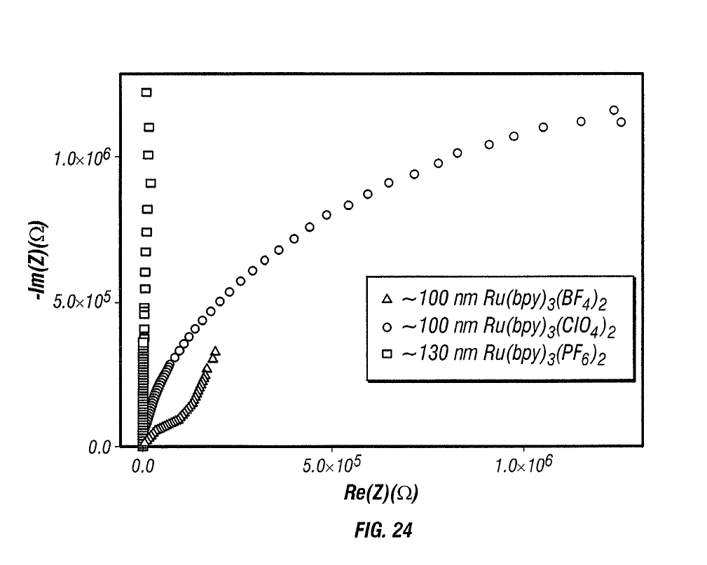

The transient behavior of these devices is strongly influenced by the mobility of the counter ion (FIG. 23). Small, mobile anions such as BF₄⁻ and ClO₄⁻ lead to fast transients (FIG. 23 top), while for large anions (PF₆⁻, AsF₆⁻) the time-response becomes very slow (FIG. 23 bottom). Thus, by changing the anion, response times can be varied by several orders of magnitude. Similar slow responses have been observed for tris(bipyridyl)ruthenium light-emitting devices using PF₆⁻ as counter ion (Handy et al., 1999). The influence of the anion mobility can also be clearly seen in the zero-bias impedance spectra (FIG. 24). At zero bias, the film resistance is related to the mobility of the anions, since no other mobile species exist in the film (the Ru(byp)₃²⁺ sites are assumed to be fixed). For the Ru(bpy)₃(PF₆)₂ and Ru(bpy)₃(AsF₆)₂ films, which have low anion mobility and therefore very large resistances, the impedance is almost a perfectly vertical line, corresponding to the geometric capacitance of the film. For Ru(bpy)₃(BF₄)₂ films, which have high anion mobility and low resistances, the impedance consists of a high-frequency circular arc and a low frequency almost vertical line, characteristic of a thin film sandwiched between two blocking electrodes (Macdonald, 1974). The case of Ru(bpy)₃(ClO₄)₂ films is intermediary only, the circular arc being observed.

C₁₂-Ru(bpy)₃(ClO₄)₂ and Ru(phenanthroline)₃(ClO₄)₂.

The inventors also fabricated LEDs with a spin-coated single layer of C₁₂-Ru(bpy)₃(ClO₄)₂ or Ru(phenanthroline)₃(ClO₄)₂ as emitter and printed Ga:Sn as the cathodic contact. Although a clearly visible red emission was generated for both LEDs, their luminance and efficiencies are much less than those using Ru(bpy)₃(ClO₄)₂ as emitter. FIGS. 19 and 20 show the emission spectra of two LEDs using C₁₂-Ru(bpy)₃(ClO₄)₂ and Ru(phenanthroline)₃(ClO₄)₂, respectively, as emitters.

Os(bpy)₃(PF₆)₂.

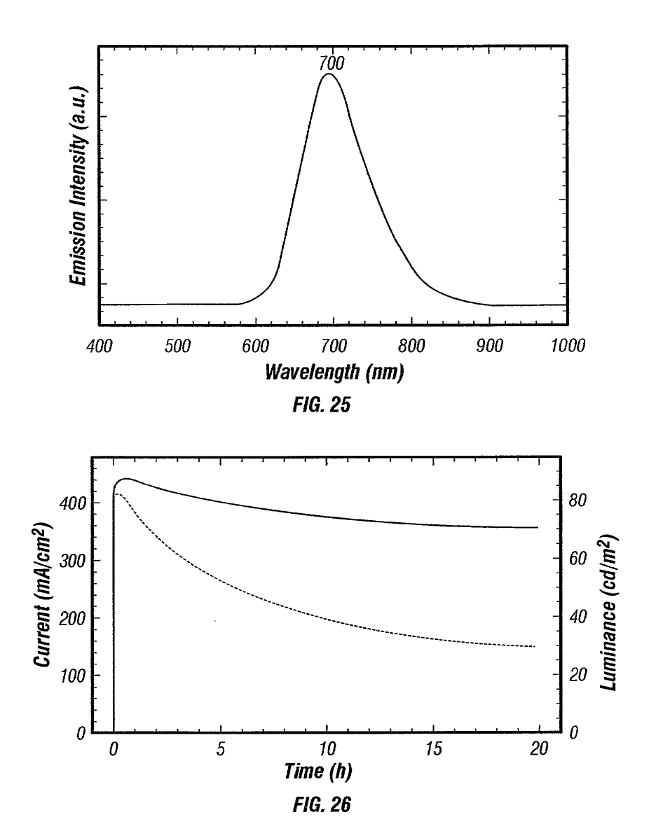

FIG. 25 shows the emission spectrum of an LED ITO/Os(bpy)₃(PF₆)₂/Ga:Sn. Although the intensity and efficiency of these are also much less than those obtained using Ru(bpy)₃(ClO₄)₂ as emitter, the emission lifetime is much longer. FIG. 26 shows the time course of the current and luminescence.

Tris(8-hydroxyquinoline) aluminum (Alq₃).

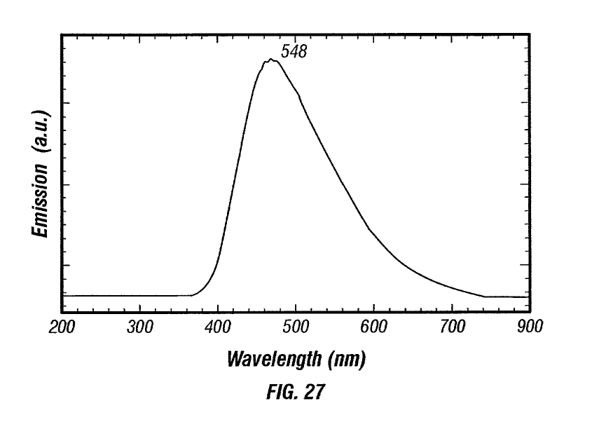

Alq₃ has been studied by other groups, but none has used low melting point alloys as cathodic contacts. A single-layer LED, ITO/Alq₃/Ga:Sn, emitted visible green-yellow light upon the application of a forward voltage bias. Its emission spectrum, with a maximum of 550 nm, is shown in FIG. 27. Printed low melting point alloys may therefore prove useful in LEDs employing small molecules, or perhaps polymers, as light emitters.

Thus, the inventors have demonstrated high brightness (3500 ed/m² at 4.0 V) and low voltage driven LEDs (turn-on voltage 2.3 V) based on amorphous and crystalline films of Ru(bpy)₃(ClO₄)₂ and related materials as emitter and using printed low melting point alloys such as Ga:In, Ga:Sn and Bi:In:Pb:Sn as cathodic contacts. The relatively short emission lifetime (hours) is probably due to quenching of the Ru(bpy)₃(ClO₄)₂ excited state by impurities in the thin film or by metal ions migrating from the contacts during operation.

### REFERENCES

The following references are incorporated herein by reference:

Adachi et al., Appl. Phys. Lett., 1989, 55, 1489.

Antoniadis et al., Appl. Phys. Lett., 1998, 73, 3055.

Baldo et al., Appl. Phys. Lett., 1999, 75, 4.

Berkovich et al., Synthetic Metals, 1999, 107, 85.

Blochwitz et al., Appl. Phys. Lett., 1998, 73, 729.

Boyd et al., Macromolecules, 1997, 30, 3553.

Burroughes et al., Nature, 1990, 347, 539.

Burrows et al., Appl. Phys. Lett., 1994, 64, 2285.

Campbell et al., Appl. Phys. Lett., 1998, 72, 1863.

Choi et al., Appl. Phys. Lett., 2000, 76, 412.

Chondroudis, K. and Mitzi, D. B., Appl. Phys. Lett., 2000, 76, 58.

Chone et al., Appl. Phys. Lett., 1998, 73, 3162.

Choong et al., Appl. Phys. Lett., 1997, 71, 1005.

Chung et al., Appl. Phys. Lett., 1999, 74, 3645.

Conwell et al., Appl. Phys. Lett., 1997, 70, 1867.

Curry et al., Appl. Phys. Lett., 1999, 75, 1380.

Donze et al., Chem. Phys. Lett., 1999, 315, 405.

Elliott et al., Am. Chem. Soc., 1998, 120, 6781.

Forrest, S. R. Chem. Rev., 1997, 97, 1793.

Gao et al., Am. Chem. Soc. 2000, 122, 7426.

Gaudiello et al., Inorg. Chem., 1984, 23, 3.

Gigli et al., Appl. Phys. Lett., 1999, 75, 439.

Hamada et al., Appl. Phys. Lett., 1997, 71, 3338.

Hamada et al., Appl. Phys. Lett., 1998, 72, 1939.

Hamada et al., Appl. Phys. Lett., 1999, 75, 1682.

Handy et al., Am. Chem. Soc., 1999, 121, 3525.

Hu et al., Appl. Chem. Soc., 1999, 121, 5097.

Huang et al., Appl. Phys. Lett., 1998, 73, 2914.

J. R. Macdonald, J. Chem. Phys., 1974, 61, 3977.

Jabbour etal., Appl. Phys. Lett., 1998, 73, 1185.

Jandke et al, Macromolecules, 1998, 31, 6434.

Kido et al., Appl. Phys. Lett., 1994, 64, 815.

Kido et al., Science, 1995, 267, 1332.

Kim et al., Appl. Phys. Lett., 2000, 76, 259.

Krausz, E.; Riesen, H.; Rae, A. D. Aust. J Chem., 1995, 48, 929.

Lee et al., Appl. Phys. Lett., 1999, 75, 1404.

Li et al., Appl. Phys. Lett., 1997a, 70, 2741.

Li et al., Appl. Phys. Lett., 1997b, 70, 1233.

Li et al., Appl Phys. Lett., 1997c, 71, 2560.

Liu, C. -Y.; Bard, A. J. Acc. Chem. Res. 1999, 32, 235-245.

Lyons et al., Am. Chem. Soc., 1998, 120, 12100.

Maness et al., Am. Chem. Soc., 1997, 119, 3987.

Maness et al, Am. Chem. Soc., 1996, 118, 10609.

McCord, P., Electroanal. Chem., 1991, 318, 91.

O'Brien et al., Appl. Phys. Lett., 1999, 74, 442.

Saito, T.; Liu, C. -Y.; Bard, A. J. Chem. Mater. 1997, 9, 1318.

Sakamoto et al., Appl. Phys. Lett., 1999, 75, 766.

Sato et al., Synth. Met., 1997, 91, 103.

Sheats et al., Acc. Chem. Res. 1999, 32, 193.

Sheats et al., Science, 1996, 273, 884.

Sprintschnik et al., Am. Chem. Soc., 1997, 99, 4947.

Strukelj et al., Am. Chem. Soc., 1996, 118, 1213.

Tang, S. W. and Vanslyke, S. A. Appl. Phys. Lett., 1987, 51, 913.

Tao et al., Am. Chem. Soc., 1999, 121, 9447.

Wu et al., Am. Chem. Soc., 1999. 121, 4883.

Xu et al., Appl. Phys. Lett, 1999, 75, 1827.

Yamamori et al., Appl. Phys. Chem., 1998, 72, 2147.

Yang et al., Synthetic Metals, 2000, 108, 95.

Zhang et al., Synthetic Metals, 1999, 106, 157.

U.S. Pat. No. 5,693,956

U.S. Pat. No. 5,151,629

U.S. Pat. No. 5,707,745

U.S. Pat. No. 5,703,436

U.S. Pat. No. 5,757,139

U.S. Pat. No. 5,707,745

U.S. Pat. No. 5,721,160

U.S. Pat. No. 5,757,026

U.S. Pat. No. 6,000,983

U.S. Pat. No. 6,015,120

U.S. Pat. No. 6,020,874

U.S. Pat. No. 6,023,258

U.S. Pat. No. 6,023,790

U.S. Pat. No. 6,024,335

U.S. Pat. No. 6,028,977

U.S. Pat. No. 6,029,831

U.S. Pat. No. 6,050,535

U.S. Pat. No. 6,059,626

U.S. Pat. No. 6,061,104

U.S. Pat. No. 6,064,373

U.S. Pat. No. 6,031,714

Although the present invention and its advantages have been described in detail, it should be understood that various changes, substitutions and alterations can be made to the embodiments described herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed:

1. A high brightness, low voltage driven thin film light-emitting device (LED) comprising:
(a) an emitter layer comprising a film of an inorganic salt; and
(b) a cathodic contact comprising a conductive material.

2. The LED of claim 1, wherein said inorganic salt is a trischelated-ruthenium (II) compound.

3. The LED of claim 1, wherein said inorganic salt is a tris(2,2′-bipyridine) osmium (II) compound.

4. The LED of claim 2, wherein said trischelated-ruthenium (II) compound is Ru(bpy)₃(ClO₄)₂.

5. The LED of claim 2, wherein said trischelated-ruthenium (II) compound is Ru(bpy)₃(PF₆)₂.

6. The LED of claim 2, wherein said trischelated-ruthenium (II) compound is Ru(bpy)₃(AsF₆)₂.

7. The LED of claim 2, wherein said trischelated-ruthenium (II) compound is Ru(bpy)₃(BF₄)₂.

8. The LED of claim 2, wherein said trischelated-ruthenium (II) compound is RU(II)(byp)₂(bpyCOOR)(ClO₄)₂.

9. The LED of claim 2, wherein said trischelated-ruthenium (II) compound is Ru(II)(phenanthroline)(ClO₄)₂.

10. The LED of claim 3, wherein said tris(2,2′-bipyridine) osmium (II) compound is Os(II)(bpy)₃(PF₆)₂.

11. The LED of claim 1, further comprising an additional layer.

12. The LED of claim 11, wherein said additional layer comprises N,N′-Bis(3-methylphenyl)-N,N′-diphenylbenzidine.

13. The LED of claim 1, wherein said conductive material is a low melting point alloy.

14. The LED of claim 13, wherein said low melting point alloy is Ga:In.

15. The LED of claim 13, wherein said low melting point alloy is Ga:Sn.

16. The LED of claim 13, wherein said low melting point alloy is Bi:In:Pb:Sn.

17. The LED of claim 1, wherein said conductive material is indium-tin oxide (ITO).

18. The LED of claim 2, further comprising an anodic contact wherein both cathodic and anodic contacts are made from the same material.

19. The LED of claim 18, wherein both anodic and cathodic contacts are made from ITO.

20. The LED of claim 2, having a turn on voltage of about 2.3 V.

21. The LED of claim 2, having a brightness of about 3500 cd/m² at 4.0 V.

22. The LED of claim 2, having a quantum efficiency of about 1.4%.

23. The LED of claim 22, having a quantum efficiency of at least 2.4%.

24. The LED of claim 23, having a quantum efficiency at least 3.4%.

25. The LED of claim 24, wherein said LED is ITO/Ru(bpy)₃(ClO₄)₂/ITO.

26. The LED of claim 2, having a power efficiency of about 0.8%.

27. A flat panel display comprising a high brightness, low voltage driven organic light-emitting device (LED) comprising:
(a) an emitter layer comprising a film of an inorganic salt; and
(b) a cathodic contact comprising a conductive material.

28. A lighting fixture comprising a high brightness, low voltage driven thin film light-emitting device (LED) comprising:
(a) an emitter layer comprising a film of an inorganic salt; and
(b) a cathodic contact comprising a conductive material.

29. A method of making an LED or OLED using a low melting point alloy as the cathode.

30. A method of making an LED or OLED comprising the step of inkjet or microcontact printing of a conductive material onto the inorganic or organic film.
